(19) United States
(12) Patent Application Publication
(10) Pub. No.: US 2011/0012341 A1
(43) Pub. Date: Jan. 20, 2011

(54) Multiple Plug Coupling for Media Lines

(75) Inventors: Andreas Suhr, Lindlar (DE); Harald Hagen, Wipperfurth (DE); Markus Hasberg, Wipperfurth (DE)

Correspondence Address: Brinks Hofer Gilson & Lione/Ann Arbor, 524 South Main Street, Suite 200, Ann Arbor, MI, 48104, US

(73) Assignee: Voss Automotive GmbH, Wipperfurth (DE)

(21) Appl. No.: 12/867,066

(22) PCT Filed: Feb. 10, 2009
(86) PCT No.: PCT/EP2009/051498

§ 371 Date: Aug. 11, 2010

(30) Foreign Application Priority Data
Feb. 15, 2008 (DE) 202008002206.1

(51) Int. Cl. F16L 39/00

(52) U.S. Cl. 285/124.3

(57) ABSTRACT

A multiple coupling (1) for simultaneously connecting or disconnecting multiple media lines, having at least two plate-type coupling parts (2, 4, 6), which each have multiple line channels (8) having a corresponding number of fluid plug connector parts (10, 12). The latter can be plugged together by joining the coupling parts (2, 4, 6) in pairs in the joint direction (14). At least one of the coupling parts (4) is additionally configured as a transverse connector (16) having at least one transverse channel (18), which runs transversely to the joint direction (14), and at least one auxiliary connector part (20, 22), which is arranged in the outer edge area of the coupling part (4).

### CROSS REFERENCE TO RELATED APPLICATIONS

This application claims priority to German Patent Application No. 20 2008 002 206.1, filed Feb. 15, 2008, and PCT Patent Application PCT/EP2009/051498, filed Feb. 10, 2009.

### FIELD OF THE INVENTION

The present invention relates to a multiple plug coupling.

### BACKGROUND OF THE INVENTION

Multiple couplings of the above referenced general type (s. the publications DE 74 21 926 U, DE 20 2005 020 263 U1, WO 2006/077264 A1 and EP 0 618 393 A1 for example) have the advantage that several media lines (fluid channels) can be connected or disconnected simultaneously and/or together. For this purpose, the plate-shaped coupling parts are provided with plug connector parts (plug and socket parts) such that by joining the coupling parts in one of the joint directions running vertically to the plate planes the plug connector parts can be plugged together and/or disconnected in the opposite direction.

It is the object of the invention to improve and/or enhance a multiple coupling of the above described type with regard to its fields of applications.

According to the present invention, this object is attained in that at least one of the coupling parts is additionally configured as a transverse connector having at least one transverse channel running transversely to the joint direction, and at least one auxiliary connector part arranged in the outer edge area of the coupling part. This advantageous embodiment provides the multiple coupling according to the present invention with an additional distribution function, as the coupling part implemented as a transverse connector is configured with at least one transverse junction. In this case, the at least one transverse channel can be connected to at least one of the available line channels. Additionally or alternatively, a transverse channel can also pass through the transverse connector independently of the other line channels. Thus, the transverse channel connects at least two auxiliary connector parts to one another which are, in particular, arranged in opposite outer edge areas of the coupling part. The one or more auxiliary connector part is preferably configured as a plug connector part (plug or socket), as a result of which transverse connections can in particular easily be made by plugging the transverse connections together or disconnected by unplugging them.

By means of the design according to the present invention a kind of modular system can be implemented, wherein several (i.e. at least two) multiple couplings are directly or indirectly connected via the transverse connectors. As a result of this, additional lines and T-junctions are advantageously unnecessary for this kind of connection.

Further advantageous characteristics of the embodiment of the invention are included in the dependent claims and the following description.

### BRIEF DESCRIPTION OF THE DRAWINGS

The invention will be explained in more detail with reference to the drawing: The drawing shows:

FIG. 1 is a perspective view of a preferred embodiment of a multiple coupling according to the present invention in the coupled state,

FIG. 2 is a top view of the multiple coupling in the direction of arrow II according to FIG. 1,

FIG. 3 is a cross section in the plane III-III in FIG. 2,

FIG. 4 is a very enlarged section along the section line IV-IV in FIG. 2,

FIG. 5 is an exemplary arrangement with several multiple couplings according to the present invention in a top view similar to FIG. 2,

FIG. 6 is another, highly schematic top view of an arrangement having two transverse connectors according to the present invention,

FIG. 7 is a section in the plane VII-VII according to FIG. 6,

FIG. 8 is an illustration similar to FIG. 7, but with an auxiliary transverse connector part,

FIG. 9 is a perspective view with two transversely connected multiple couplings,

FIG. 10 is a side view (scaled down) in the direction of arrow X according to FIG. 9,

FIG. 11 is a scaled down schematized view corresponding to FIG. 9,

FIG. 12 is an enlarged cross section in the plane XII-XII in FIG. 10,

FIG. 13 is a perspective view of two multiple couplings that are transversely connected in an indirect manner via a third coupling,

FIG. 14 is a side view (arrow direction XIV in FIG. 13),

FIG. 15 is a schematic front view corresponding to FIG. 13, and

FIG. 16 is an enlarged cross section in the plane XII-XII in FIG. 14.

### DETAILED DESCRIPTION OF THE INVENTION

Identical parts are always provided with identical reference numbers in the different figures of the drawing.

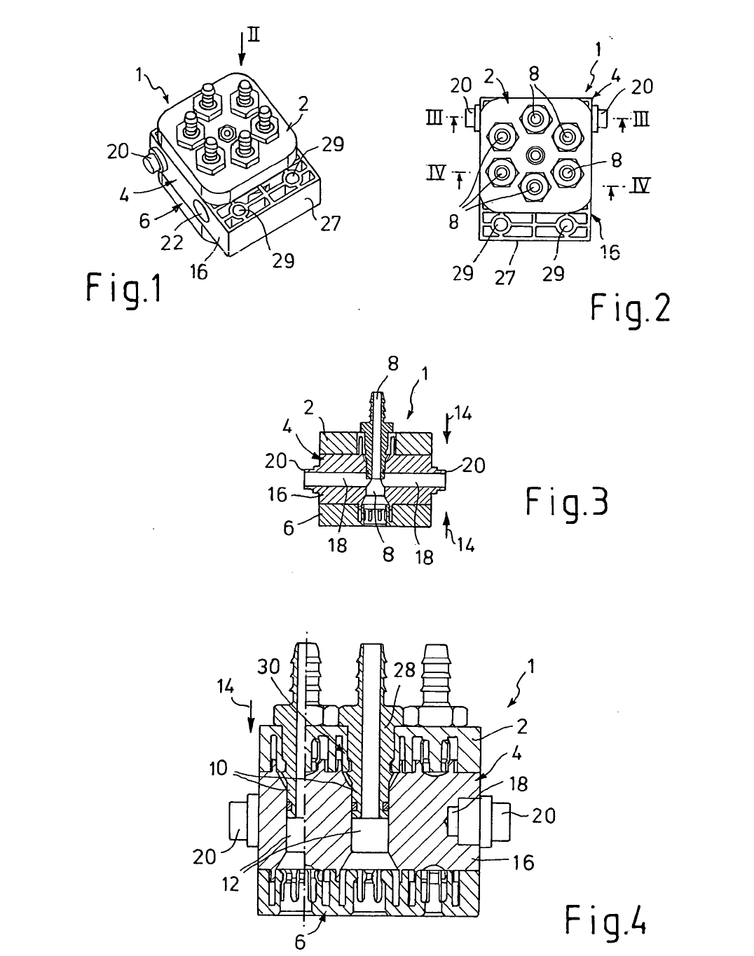

The multiple coupling 1 according to the present invention is used for simultaneously connecting or disconnecting multiple media lines and/or fluid channels in flow and/or pressure media systems of any type. For this purpose, the multiple coupling 1 has at least two plate-type coupling parts 2 and 4. An additional third plate-shaped coupling part 6 is provided in each of the preferred embodiments according to FIG. 1 to 4 and FIG. 9 to 16. These coupling parts each have several line channels 8 having a corresponding number of fluid plug connector parts, namely plugs 10 on the one side and socket openings 12 on the other side such that these fluid plug connector parts 10 and 12 can be connected to and/or inversely disconnected from one another by joining the respective coupling parts 2 and 4 and/or 4 and 6 in pairs in a vertical joint direction 14 relative to the plate planes.

According to the present invention, at least one of the coupling parts, like the coupling part 4 in the exemplary illustration, is additionally configured as a transverse connector 16 having at least one transverse channel 18, which runs transversely to the joint direction 14, and at least one auxiliary connector part allocated to it arranged in the outer edge area of the coupling part 4, the auxiliary connector part in turn preferably being configured as a plug connector part; namely, as plug 20 or socket 22.

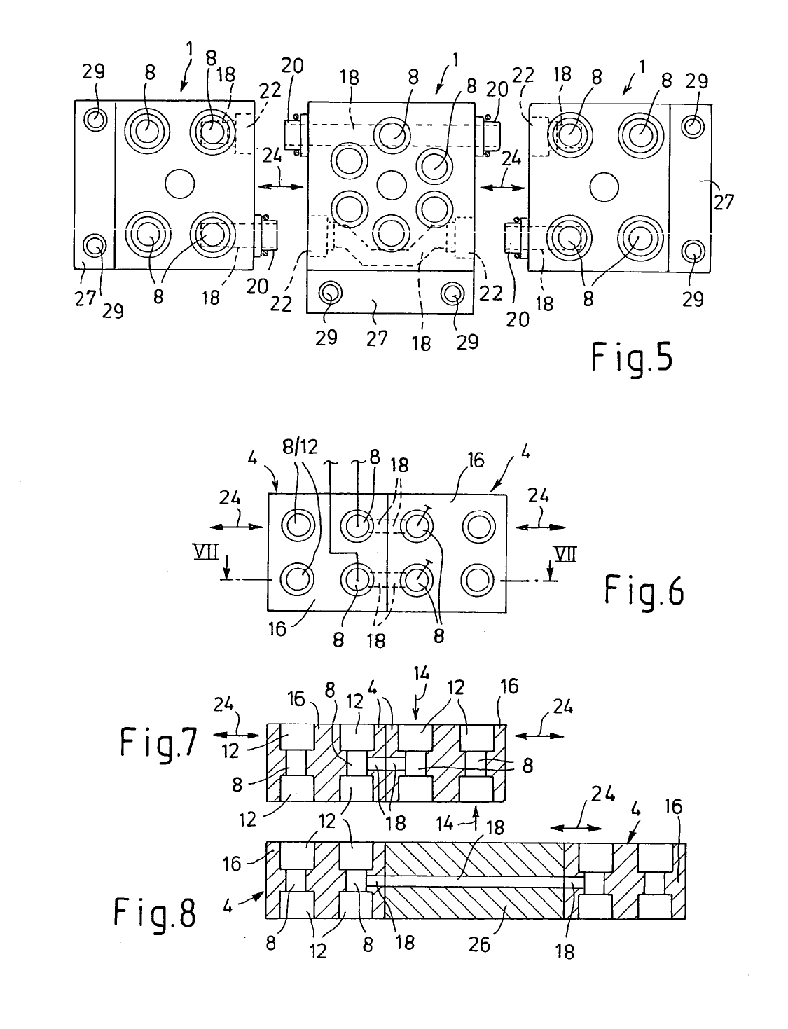

The transverse channel 18 can be fluidically connected to at least one of the line channels 8. In this regard, reference is made to FIG. 3, FIG. 5, upper area, as well as to FIGS. 7, 8, 12 and 16. The transverse channel 18 or another one can also pass through the coupling part 4 that forms the transverse connector 16 independently of the line channels 8 (cf. the middle, lower area in FIGS. 5 and 16). In this case, at least one auxiliary plug connector part 20 or 22 is allocated to each transverse channel 18 (FIGS. 12 and 16). It is also possible that the transverse channel at least connects two auxiliary plug connector parts 20 and/or 22 to one another which are then in particular arranged in opposite outer edge areas of the coupling part 4 and/or of the transverse connector 16 (FIGS. 1 to 5 and 16).

In another preferred embodiment, the transverse connector 16 that forms the coupling part, the coupling part 4 in the illustrated example, has an even number of auxiliary plug connector parts 20 and 22, which are respectively arranged as well as configured half as plugs 20 and half as sockets 22, such that the transverse connector 16 can be coupled to at least one additional identical or similar transverse connector 16 in the vertical transverse direction 24 relative to the joint direction 14. A modular system can thus be implemented, wherein the components can be in part configured as “identical parts”.

According to FIGS. 6 and 7 as well as 9 through 12, two coupling parts 4 of two couplings B (FIG. 11) can, for example, be directly coupled to one another in the transverse joint direction 24. According to FIG. 8, two transverse connectors 16 can also be coupled indirectly via a special auxiliary transverse connector 26, or, according to FIGS. 5, and 13 through 16 via a transverse connector 16. According to FIG. 15, two couplings B can thus be transversely connected via a coupling A. The auxiliary transverse connector 26 need not be part of a multiple coupling.

In another preferred embodiment, the coupling part (e.g. 4) configured as a transverse connector 16 exclusively has socket openings 12 as fluid plug connector parts for plugging in plug parts 10 of each of the other coupling parts 2 and 6. The one or more transverse connector 16 can further have at least one mounting portion 27 with fastening holes 29 protruding at the edges. Furthermore, it is advantageous if the plug parts 10 of the coupling parts 2 and/or 6 are configured as separate components 28 which are in particular held fixed in receiving openings of each coupling part 2, 6 via locking means 30. Details of this preferred embodiment are also described in the publications EP 0 618 393 A1 and WO 2006/077264 A1, for which reason these publications are hereby incorporated in full by reference.

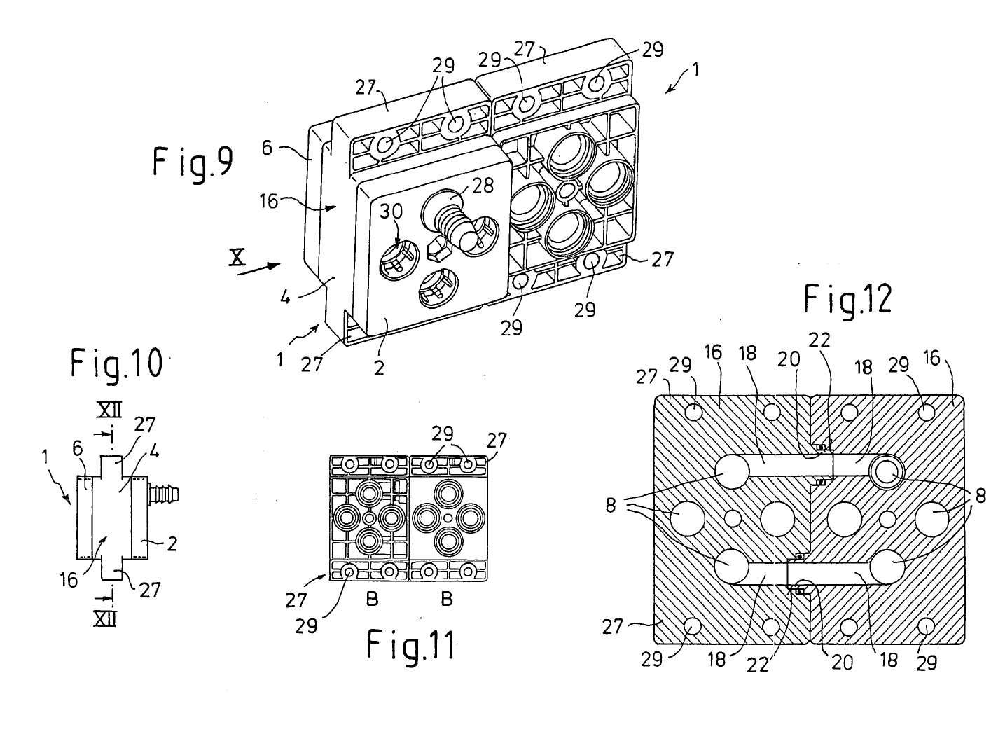

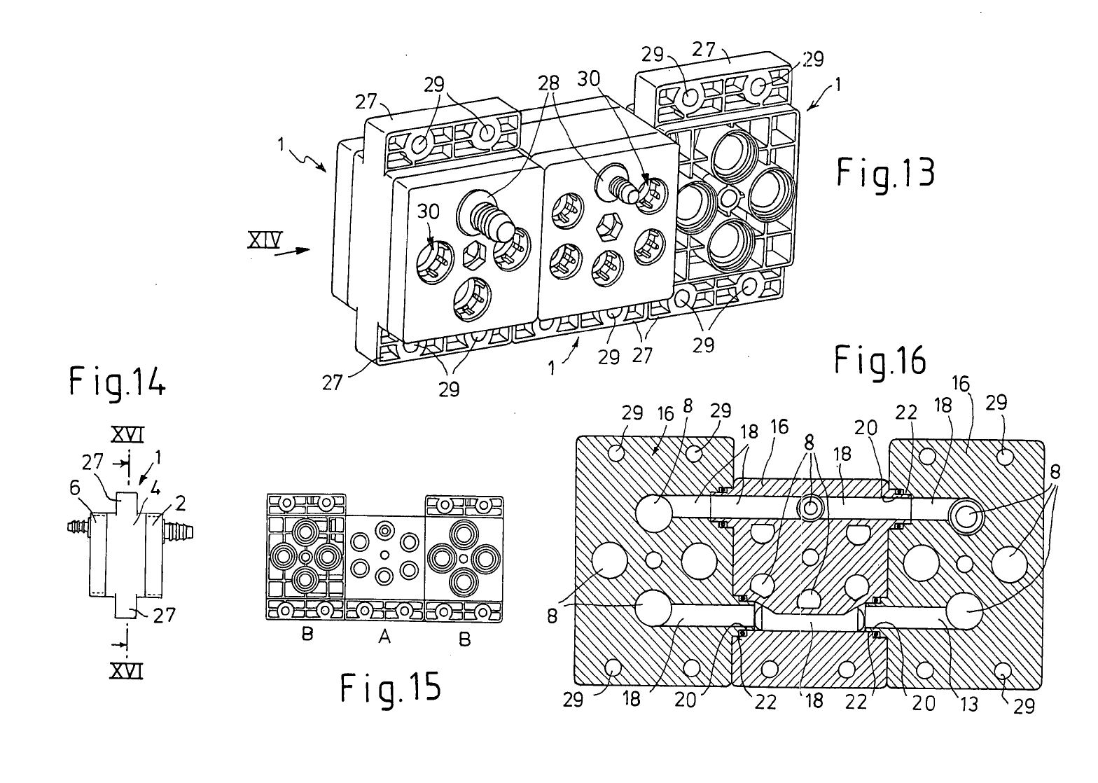

The one or more transverse connector 16 is preferably made as a one-piece molded part, in particular of plastic (cf. FIGS. 9 and 13 in particular).

The invention is not restricted to the illustrated and described exemplary embodiments, but also comprises all identically functioning designs consistent with the invention. The auxiliary connector parts thus do not necessarily have to be configured as plug connectors for the transverse connections. They can, for example, at least in part be screw connections (internal and/or external thread sections), in particular for connecting lines. The preferred plug connectors of the transverse connectors 16 can all be configured as sockets 22 (or plugs 20) which can then be connected in pairs via separate double plugs (double sockets).

Furthermore, the invention has not yet been restricted to the combination of characteristics defined in the claims, but can also be defined by any other combination of certain characteristics of all disclosed individual characteristics.

While the above description constitutes the preferred embodiment of the present invention, it will be appreciated that the invention is susceptible to modification, variation, and change without departing from the proper scope and fair meaning of the accompanying claims.

1. A multiple coupling (1) for simultaneously connecting or disconnecting multiple media lines, comprising the coupling having at least two plate-type coupling parts (2, 4, 6), which each have multiple line channels (8) having a corresponding number of fluid plug connector parts (10, 12) such that the connector parts can be plugged together by joining the coupling parts (2, 4, 6) in pairs in the joint direction (14), wherein at least one of the coupling parts (4) is additionally configured as a transverse connector (16) having at least one transverse channel (18) which runs transversely to the joint direction (14), and at least one auxiliary connector part (20, 22) which is arranged in the outer edge area of the at least one coupling part (4).

2. The multiple coupling according to claim 1, further comprising in that the transverse channel (18) is connected to at least one of the line channels (8).

3. A multiple coupling according to claim 1, further comprising in that the transverse channel (18) passes through one of the coupling parts that forms the transverse connector (16) independently of the line channels (8).

4. A multiple coupling according to claim 1, further comprising in that the transverse channel (18) connects at least two of the auxiliary connector parts (20, 22) to one another which are arranged in opposite outer edge areas of the at least one coupling part (4).

5. A multiple coupling according to claim 1 4, further comprising in the at least one coupling part (4) that forms the transverse connector (16) has an even number of the auxiliary connector parts (20, 22), which are respectively arranged and configured half as plugs (20) and half as sockets (22), such that the transverse connector (16) can be coupled with at least one other identical or similar transverse connector (16) in the transverse joint direction (24) relative to the joint direction (14) by plugging them together.

6. A multiple coupling according to claim 1, further comprising in that two of the coupling parts (4) identically configured as transverse connectors (16) can be directly or indirectly coupled to one another in the transverse joint direction (24) via another of the transverse connectors (16) on a special auxiliary transverse connector (26).

7. A multiple coupling according to claim 1, further comprising in that the coupling part (4) that forms the transverse connector (16) has socket openings (12) as fluid plug connector parts for plugging in the coupling part.

8. A multiple coupling according to claim 1 further comprising in that the coupling part (4) that forms the transverse connector (16) can correspondingly be coupled at its side facing the second coupling part (2) to another, third coupling part (6).

9. A multiple coupling according to claim 7, further comprising in that the fluid connector parts in the form of plug parts (10) of the second coupling part (2) and another of the fluid connector parts (6) are configured as separate components (28) which are held fixed in receiving openings of one of the connector parts (2, 6) via locking parts (30).
